(19) United States
(12) Patent Application Publication
(10) Pub. No.: US 2002/0178929 A1
(43) Pub. Date: Dec. 5, 2002

(54) Biscotti manufacturing system

(76) Inventors: Robert J. Davis, Grass Valley, CA (US); Theresa H. Parello, Cleveland, OH (US)

Correspondence Address: Michael S. Neustel, Suite No. 4, 2534 South University Drive, Fargo, ND, 58103, US

(21) Appl. No.: 10/135,904

(22) Filed: Apr. 29, 2002

Related U.S. Application Data
(60) Provisional application No. 60/287,815, filed on May 2, 2001.
(60) Provisional application No. 60/287,816, filed on May 2, 2001.

(51) Int. Cl. A23P 1/00; A47J 43/18

(52) U.S. Cl. 99/426; 99/448

(57) ABSTRACT

A biscotti manufacturing system for easily and efficiently producing biscotti cookies. The biscotti manufacturing system includes a baking pan having a base, a first wall, a second wall, a plurality of partitions between the walls, and a plurality of channels within for receiving the biscotti dough. The user prepares the desired amount of biscotti dough and then utilizing an applicator fills the channels of the baking pan with desired portions of the biscotti dough. The baking pan with the biscotti dough is then baked. After the biscotti dough is fully cooked, the user then removes the biscotti cookies from the baking pan.

### CROSS REFERENCE TO RELATED APPLICATIONS

I hereby claim benefit under Title 35, United States Code, Section 119(e) of U.S. provisional patent application Serial Nos. 60/287,815 (filed on May 2, 2001) and 60/287,816 (filed on May 2, 2001). Both provisional patent applications are currently pending. The 60/287,815 application and the 60/287,816 are both hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to biscotti baking systems and more specifically it relates to a biscotti manufacturing system for easily and efficiently producing biscotti cookies.

2. Description of the Related Art

Biscotti cookies and related baking methods have been in use for years. A conventional biscotti cookie is produced by (1) preparing the biscotti dough, (2) forming the biscotti dough into a loaf structure, (3) positioning the loaf of biscotti dough upon a flat pan, (4) baking the loaf of biscotti dough within an oven, (5) removing the baked biscotti loaf from the oven, (6) carefully slicing the loaf into a plurality of crescent shaped biscotti cookies (i.e. the familiar biscotti cookie shape), (7) placing the plurality of biscotti cookies upon a flat pan, (8) baking the plurality of biscotti cookies until fully toasted within the oven, and (9) removing the plurality of biscotti cookies from the oven. The flat pan used in steps (3) through (5) may alternatively be replaced with pan having a rectangular shaped cavity structure.

The main problem with conventional biscotti baking systems is that they are time consuming and labor intensive to utilize. Another problem with conventional biscotti baking systems is that they require the user to be extremely careful in handling and cutting the first baked biscotti loaf because of the fragile structure of the biscotti loaf. A further problem with conventional biscotti baking systems is that they typically do not provide a consistent biscotti cookie because the loaf is often times over-baked and under-baked in certain sections with the over-baked sections crumbling during cutting and the under-baked sections distorting during cutting of the loaf. Another problem with conventional biscotti baking systems is that they require the user to cut the biscotti cookies and then toast the cookies a second time. A further problem with conventional biscotti baking systems is that they typically do not produce a uniform shaped biscotti cookie because of the inherent variation in shape of the loaf.

While these devices may be suitable for the particular purpose to which they address, they are not as suitable for easily and efficiently producing biscotti cookies. Conventional biscotti baking systems are inefficient, difficult to utilize and do not produce a uniform biscotti cookie.

In these respects, the biscotti manufacturing system according to the present invention substantially departs from the conventional concepts and designs of the prior art, and in so doing provides an apparatus primarily developed for the purpose of easily and efficiently producing biscotti cookies.

### BRIEF SUMMARY OF THE INVENTION

In view of the foregoing disadvantages inherent in the known types of biscotti manufacturing systems now present in the prior art, the present invention provides a new biscotti manufacturing system construction wherein the same can be utilized for easily and efficiently producing biscotti cookies.

The general purpose of the present invention, which will be described subsequently in greater detail, is to provide a new biscotti manufacturing system that has many of the advantages of the biscotti systems mentioned heretofore and many novel features that result in a new biscotti manufacturing system which is not anticipated, rendered obvious, suggested, or even implied by any of the prior art biscotti systems, either alone or in any combination thereof.

To attain this, the present invention generally comprises a baking pan having a base, a first wall, a second wall, a plurality of partitions between the walls, and a plurality of channels within for receiving the biscotti dough. The user prepares the desired amount of biscotti dough and then utilizing an applicator creates the desired crescent shaped biscotti cookies within the channels of the baking pan. The baking pan with the biscotti dough is then baked. After the biscotti dough is fully cooked, the user then removes the biscotti cookies from the baking pan.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a biscotti manufacturing system that will overcome the shortcomings of the prior art devices.

A second object is to provide a biscotti manufacturing system for easily and efficiently producing biscotti cookies.

Another object is to provide a biscotti manufacturing system that may be utilized by the average consumer of biscotti cookies.

An additional object is to provide a biscotti manufacturing system that produces a uniform biscotti cookie.

A further object is to provide a biscotti manufacturing system that produces biscotti cookies with a single baking step.

Another object is to provide a biscotti manufacturing system that reduces the amount of time and labor required to produce biscotti cookies.

A further object is to provide a biscotti manufacturing system that produces evenly baked biscotti cookies.

Another object is to provide a biscotti manufacturing system that simultaneously bakes, slices and toasts a plurality of biscotti cookies within a single step.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with biscotti dough being inserted within the channels of the baking pan.

FIG. 3 is a cross sectional view taken along line 3-3 of FIG. 2.

FIG. 4 is a cross sectional view taken along line 4-4 of FIG. 2.

FIG. 5 is an end view of the present invention.

FIG. 6 is a side view of the present invention.

FIG. 7 is a bottom view of the present invention.

FIG. 8 is a top view of the present invention.

FIG. 9 is a flowchart illustrating the process of producing biscotti cookies within the present invention.

### DETAILED DESCRIPTION OF THE INVENTION

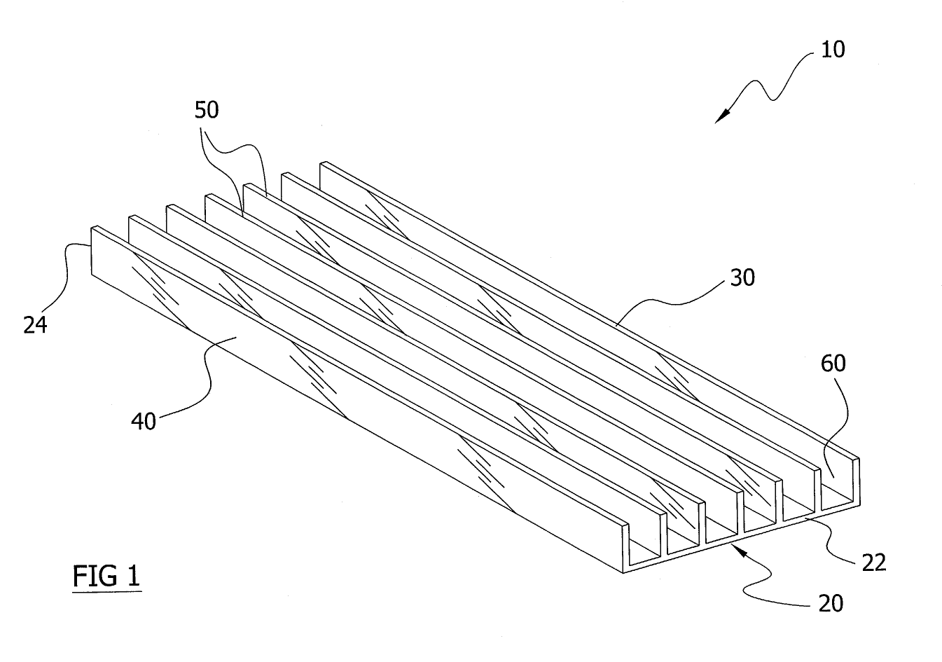

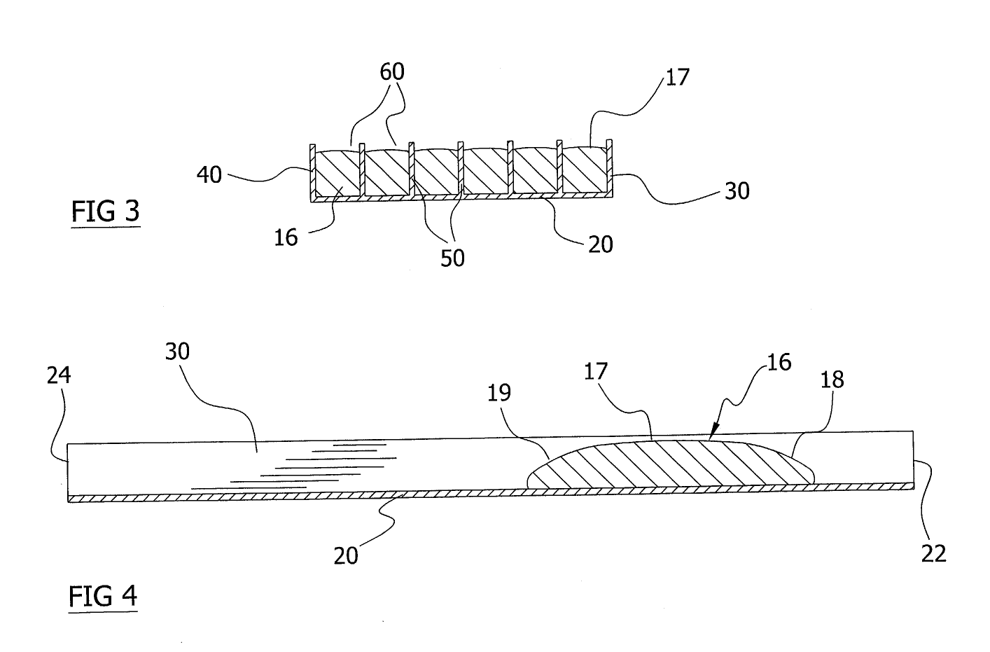

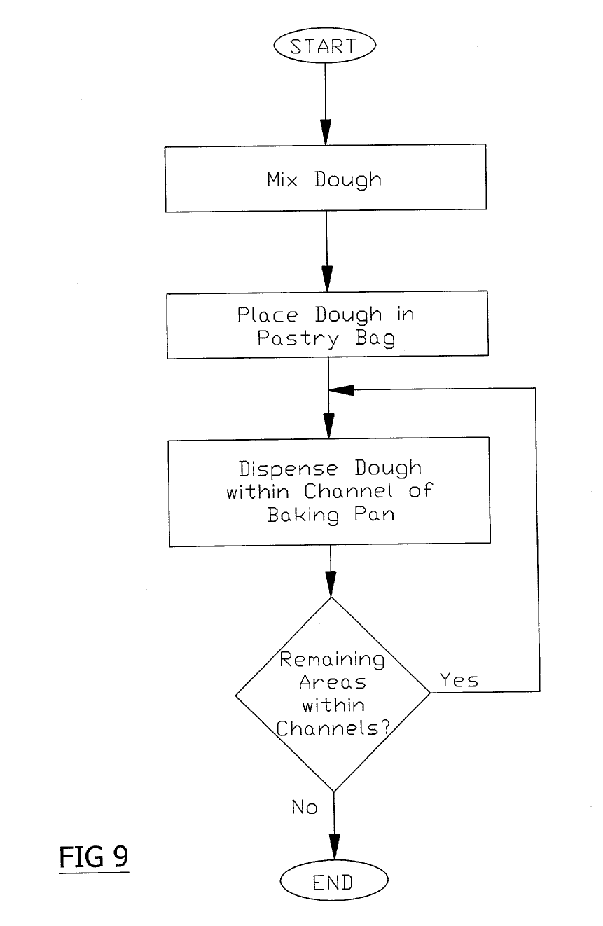

Turning now descriptively to the drawings, in which similar reference characters denote similar elements throughout the several views, FIGS. 1 through 9 illustrate a biscotti manufacturing system, which comprises a baking pan 10 having a base 20, a first wall 30, a second wall 40, a plurality of partitions between the walls, and a plurality of channels 60 within for receiving the biscotti dough. The user prepares the desired amount of biscotti dough and then utilizing an applicator 12 creates a desired shape within the channels 60 of the baking pan 10. The baking pan 10 with the biscotti dough is then baked. After the biscotti dough is fully cooked, the user then removes the biscotti cookies 16 from the baking pan 10.

As shown in FIGS. 1 through 6 of the drawings, the baking pan 10 includes a base 20, a first wall 30, a second wall 40, a plurality of partitions between the walls, and a plurality of channels 60 within for receiving the biscotti dough. The baking pan 10 may be constructed of various materials such as but not limited to aluminum, steel, stainless steel, brass, metals, non-metals, composite materials and other suitable materials capable of withstanding baking temperatures exceeding 350 degrees Fahrenheit. The material utilized to construct the baking pan 10 is preferably heat conductive for evenly transferring heat throughout the baking pan 10 and the biscotti cookies 16.

The baking pan 10 may be produced by various manufacturing methods such as but not limited to extrusion or other processes. The baking pan 10 may further have a non-stick coating applied such as polytetrafluoroethylene (currently manufactured under the brand name TEFLON by DUPONT) to reduce sticking of the biscotti cookies 16 during cooking for easy removal thereof from the baking pan 10.

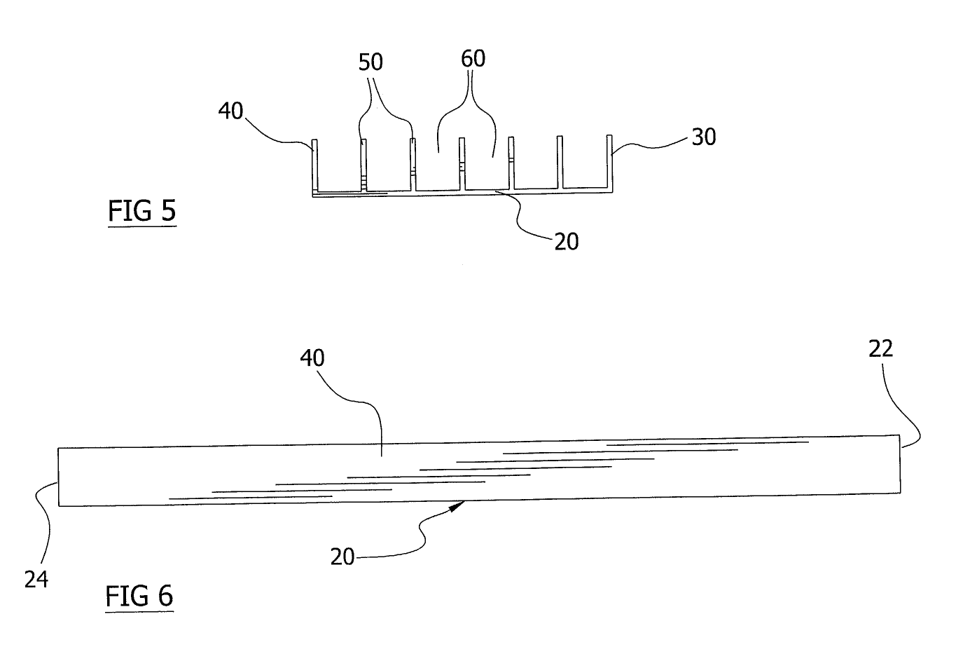

As best shown in FIG. 5 of the drawings, the base 20 preferably has a flat and straight structure with an upper surface and a lower surface. The base 20 preferably has a rectangular shape that has a longitudinal axis as best shown in FIG. 7 of the drawings. The upper surface receives a lower portion of the biscotti dough during cooking with the lower surface positioned upon a rack within the baking unit (e.g. oven). The baking pan 10 has a first end 22 and a second end 24 as best shown in FIGS. 1, 2 and 4 of the drawings.

As shown in FIGS. 1, 2 and 5 of the drawings, a first wall 30 extends from the base 20 substantially parallel to the longitudinal axis of the base 20. The first wall 30 preferably extends upwardly from the upper surface of the base 20 in an orthogonal manner as best shown in FIG. 5 of the drawings. The first wall 30 preferably has a rectangular shape having a consistent height. The height of the first wall 30 preferably is between 0.75 to 1.5 inches, however greater or less height may be utilized to construct the first wall 30.

As shown in FIGS. 1, 2 and 5 of the drawings, a second wall 40 extends from the base 20 substantially parallel to the longitudinal axis of the base 20 and parallel to the first wall 30. The second wall 40 is positioned upon the opposing side of the base 20 as the first wall 30 as shown in FIGS. 1, 2 and 3 of the drawings. The second wall 40 preferably extends upwardly from the upper surface of the base 20 in an orthogonal manner as best shown in FIG. 5 of the drawings.

The second wall 40 preferably has a rectangular shape having a consistent height similar to the first wall 30. The height of the second wall 40 preferably is between 0.75 to 1.5 inches, however greater or less height may be utilized to construct the second wall 40. The height of the first wall 30 and the second wall 40 is preferably sufficient for receiving the entire height of the biscotti dough as positioned within the channels 60.

As shown in FIGS. 1, 2, 3, 5 and 8 of the drawings, a plurality of inner partitions 50 extend from the base 20 substantially parallel to the longitudinal axis of the base 20 and parallel to the first wall 30 and the second wall 40. The inner partitions 50 are positioned between the first wall 30 and the second wall 40 as shown in FIGS. 1, 2 and 3 of the drawings. The inner partitions 50 preferably extend upwardly from the upper surface of the base 20 in an orthogonal manner as best shown in FIG. 5 of the drawings.

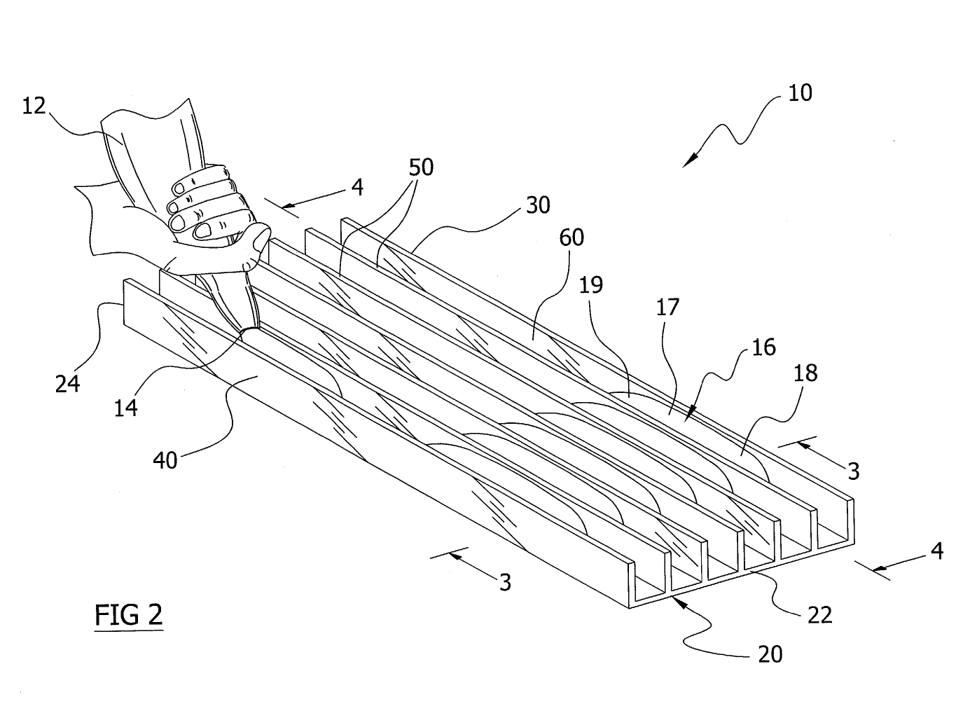

As shown in FIGS. 1 and 2 of the drawings, the inner partitions 50 preferably have a rectangular shape having a consistent height similar to the first wall 30 and the second wall 40. The height of each of the inner partitions 50 preferably is between 0.75 to 1.5 inches, however greater or less height may be utilized to construct the inner partitions 50 depending upon the size of biscotti cookies 16 desired to be produced. As best shown in FIG. 5 of the drawings, the height of the first wall 30, second wall 40 and inner partitions 50 are preferably equal to one another. The distal ends of the walls 30, 40 and inner partitions 50 are preferably open thereby allowing for the user to easily remove the baked biscotti cookies 16 by sliding the same outwardly from the channels 60.

It can be appreciated that one or more inner partitions 50 may be utilized between the outer walls 30, 40 and alternatively no inner partitions 50 where the walls 30, 40 form a single channel 60. However, the number of inner partitions 50 preferably is greater than four for creating five or more channels 60 within the baking pan 10. FIGS. 1, 2, 3 and 5 illustrate the usage of five inner partitions 50 thereby forming six channels 60 within the baking pan 10. The number of channels 60 is calculated by increasing the total number of inner partitions 50 by one. For example, if three inner partitions 50 are utilized, then there are four channels 60. If no inner partitions 50 are utilized, then there is only one channel 60 within the baking pan 10.

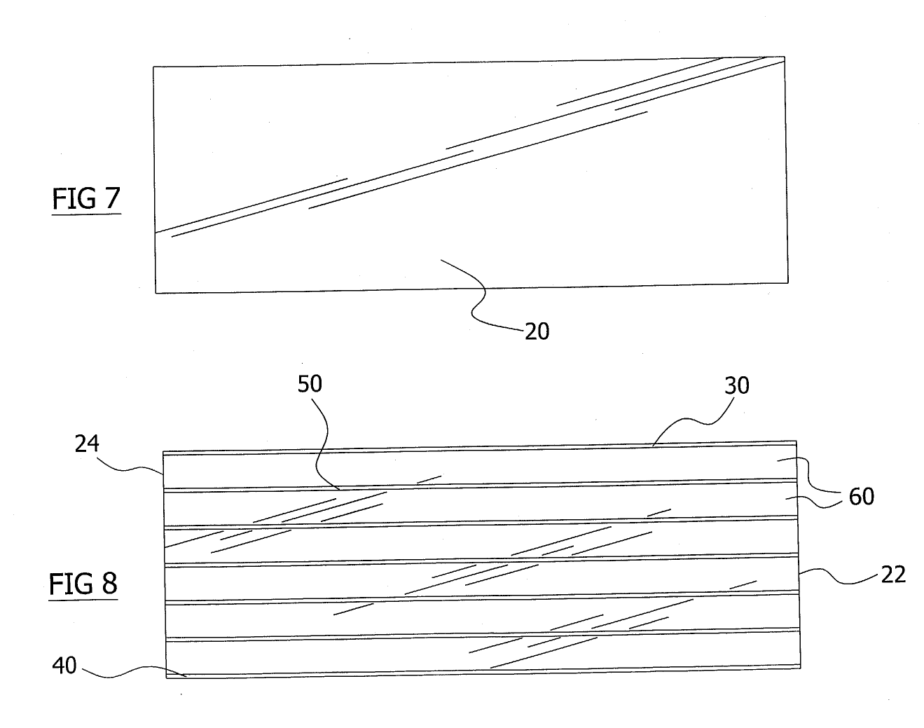

The plurality of inner partitions 50 are preferably positioned equal distances apart from another and the outer walls 30, 40 thereby forming a plurality of channels 60 between thereof. The channels 60 each have an elongate rectangular structure extending between the walls and/or inner partitions 50 as best shown in FIGS. 1 and 8 of the drawings. Each of the channels 60 preferably has the same width, however, the width may vary amongst the channels 60. The width of each of the channels 60 is preferably between 0.5 to 1.0 inches, however a greater or less width may be utilized depending upon the size of biscotti cookies 16 desired to be produced.

Various biscotti recipes exist for producing the biscotti dough which may be utilized within the present invention. If an extrusion applicator 12 (e.g. pastry bag) is to be utilized for creating the biscotti cookies 16, the user may “thin” the biscotti dough to facilitate dispersing of the biscotti dough from the applicator 12 such as but not limited to increasing the amount of milk and/or butter utilized within the recipe. A common recipe for biscotti dough includes the ingredients of flour, baking powder, salt, butter, sugar, eggs, milk and a flavoring such as almond extract or vanilla. Various other recipes may be utilized within the present invention to produce the biscotti dough, therefore the above discussion should not limit the present invention to a specific type of biscotti dough.

In use, the user may coat the baking pan 10 with a cooking spray prior to inserting the biscotti dough into the channels 60. If the biscotti dough utilized has a thicker consistency, the user may divide the biscotti dough into equal sized portions which are then formed into any desired shape. The formed portions are then placed within the channels 60 of the baking pan 10. If the biscotti dough utilized has a thinner consistency, the user may insert the biscotti dough within the applicator 12 and then dispense the biscotti dough directly within the channels 60 from the nozzle 14 of the applicator 12 to create individual biscotti cookies 16 as shown in FIG. 2 of the drawings. It is important to leave sufficient space between each of the biscotti cookies 16 to ensure that they do not become in contact with one another during baking. The baking pan 10 is then positioned within a heated oven to bake the biscotti cookies 16 within the baking pan 10. The inner partitions 50 and walls 30, 40 evenly distribute the heat between the biscotti cookies 16 to ensure that the biscotti cookies 16 are uniformly and evenly baked. The portions of biscotti dough within the baking pan 10 during heating thereof naturally form a desired crescent shaped structure. After the biscotti cookies 16 are fully cooked, the user then removes the baking pan 10 from the oven and then removes the biscotti cookies 16 from the baking pan 10. The biscotti cookie will typically have a middle portion 17, a first portion 18 and a second portion 19 forming a crescent shaped structure similar to the conventional biscotti cookie shape commonly utilized. The removal of the baked biscotti cookies 16 by either grasping the biscotti cookies 16 individually, sliding the biscotti cookies 16 out the open ends of the baking pan 10, or inverting the baking pan 10. Additional processes may be applied to the biscotti cookies 16 after removal such as but not limited to glazing or the like. It can be appreciated that commercial settings may utilize a plurality of baking pans 10 in a continuous manner.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

| ▭ | ENVIRONMENTAL ELEMENTS | ▭ | 40. Second Wall |
|---|---|---|---|
| ▭ | | ▭ | 41. |
| ▭ | | ▭ | 42. |
| ▭ | | ▭ | 43. |
| ▭ | | ▭ | 44. |
| ▭ | | ▭ | 45. |
| ▭ | | ▭ | 46. |
| ▭ | | ▭ | 47. |
| ▭ | | ▭ | 48. |
| ▭ | | ▭ | 49. |
| ▭ | 10. Baking Pan | ▭ | 50. Inner Partitions |
| ▭ | 11. | ▭ | 51. |
| ▭ | 12. Applicator | ▭ | 52. |
| ▭ | 13. | ▭ | 53. |
| ▭ | 14. Nozzle | ▭ | 54. |
| ▭ | 15. | ▭ | 55. |
| ▭ | 16. Biscotti Cookie | ▭ | 56. |
| ▭ | 17. Middle Portion | ▭ | 57. |
| ▭ | 18. First Portion | ▭ | 58. |
| ▭ | 19. Second Portion | ▭ | 59. |
| ▭ | 20. Base | ▭ | 60. Channels |
| ▭ | 21. | ▭ | 61. |
| ▭ | 22. First End | ▭ | 62. |
| ▭ | 23. | ▭ | 63. |
| ▭ | 24. Second End | ▭ | 64. |
| ▭ | 25. | ▭ | 65. |
| ▭ | 26. | ▭ | 66. |
| ▭ | 27. | ▭ | 67. |
| ▭ | 28. | ▭ | 68. |
| ▭ | 29. | ▭ | 69. |
| ▭ | First Wall | ▭ | 70. |
| ▭ | 31. | ▭ | 71. |
| ▭ | 32. | ▭ | 72. |
| ▭ | 33. | ▭ | 73. |
| ▭ | 34. | ▭ | 74. |
| ▭ | 35. | ▭ | 75. |
| ▭ | 36. | ▭ | 76. |
| ▭ | 37. | ▭ | 77. |
| ▭ | 38. | ▭ | 78. |
| ▭ | 39. | ▭ | 79. |

We claim:

1. A biscotti baking pan, comprising:
a base;
a first wall extending orthogonally from said base;
a second wall extending orthogonally from said base opposite of said first wall; and
at least one inner partition extending orthogonally from said base between said first wall and said second wall forming a plurality of channels between thereof.

2. The biscotti manufacturing system of claim 1, wherein said at least one inner partition is comprised of a plurality of inner partitions.

3. The biscotti manufacturing system of claim 2, wherein said plurality of inner partitions is comprised of at least four inner partitions.

4. The biscotti manufacturing system of claim 1, wherein said first wall, said second wall, and said at least one inner partition are all parallel to one another.

5. The biscotti manufacturing system of claim 1, wherein said first wall, said second wall and said at least one inner partition have a rectangular shape.

6. The biscotti manufacturing system of claim 1, wherein said base has an elongate rectangular shape, wherein said plurality of channels are parallel to a longitudinal axis of said base.

7. The biscotti manufacturing system of claim 1, wherein said plurality of channels have an equal width.

8. The biscotti manufacturing system of claim 1, wherein said first wall, said second wall and said at least one inner partition have an equal height.

9. The biscotti manufacturing system of claim 1, wherein said plurality of channels have a width between 0.50 to 1.0 inches.

10. The biscotti manufacturing system of claim 1, wherein said first wall, said second wall and said at least one inner partition have a height of between 0.75 to 1.50 inches.

11. A biscotti baking pan, comprising:
a base having a first end, a second end and a longitudinal axis, wherein said base is comprised of a rectangular shape;
a first wall extending orthogonally from a first side of said base;
a second wall extending orthogonally from a second side of said base opposite of said first wall; and
at least one inner partition extending orthogonally from said base between said first wall and said second wall forming a plurality of channels between thereof;
wherein said first wall, said second wall and said at least one inner partition extend from said first end to said second end of said base.

12. The biscotti manufacturing system of claim 11, wherein said at least one inner partition is comprised of a plurality of inner partitions.

13. The biscotti manufacturing system of claim 12, wherein said plurality of inner partitions is comprised of at least four inner partitions.

14. The biscotti manufacturing system of claim 11, wherein said first wall, said second wall, and said at least one inner partition are all parallel to one another.

15. The biscotti manufacturing system of claim 11, wherein said first wall, said second wall and said at least one inner partition have a rectangular shape.

16. The biscotti manufacturing system of claim 11, wherein said base has an elongate rectangular shape, wherein said plurality of channels are parallel to a longitudinal axis of said base.

17. The biscotti manufacturing system of claim 11, wherein said plurality of channels have an equal width.

18. The biscotti manufacturing system of claim 11, wherein said first wall, said second wall and said at least one inner partition have an equal height.

19. The biscotti manufacturing system of claim 11, wherein said plurality of channels have a width between 0.50 to 1.0 inches, and wherein said first wall, said second wall and said at least one inner partition have a height of between 0.75 to 1.50 inches.

20. A method of producing biscotti cookies utilizing a baking pan having a base, a first wall extending orthogonally from said base, a second wall extending orthogonally from said base opposite of said first wall, and at least one inner partition extending orthogonally from said base between said first wall and said second wall forming a plurality of channels between thereof, said method comprising the steps of:
(a) preparing a volume of biscotti dough;
(b) inserting a first volume of said biscotti dough within one of said plurality of channels of said baking pan;
(c) repeating step (b) until a desired number of biscotti cookies are formed;
(d) baking said baking pan with said biscotti cookies within; and
(e) removing said biscotti cookies from said baking pan.
